(19) United States
(12) Patent Application Publication
(10) Pub. No.: US 2008/0052981 A1
(43) Pub. Date: Mar. 6, 2008

(54) Tip-up fishing device for ice fishing

(76) Inventor: Wayne Francis Richardson, Endwell, NY (US)

Correspondence Address: WAYNE F. RICHARDSON, 1130 ARNOLD DR., ENDWELL, NY, 13760, US

(21) Appl. No.: 11/513,604

(22) Filed: Aug. 31, 2006

(51) Int. Cl. A01K 97/12; A01K 97/10

(52) U.S. Cl. 43/17; 43/21.2

(57) ABSTRACT

An ice fishing system is provided including a one piece base with two masts arising there from. Also included is a curved fishing pole which is coupled to the base with a U-shaped pin and upon which the pole resides. This U-shaped pin also allows the pole to rock to and fro between the masts and this pole has a fishing line that depends from an end thereof.

### FIELD OF THE INVENTION

The present invention relates to ice fishing and, more particularly, to a device designed to detect the slightest strikes from fish. The device is designed to be durable and simple to operate in the harsh environment associated with ice fishing . . .

### BACKGROUND OF THE INVENTION

Since the beginning of recorded history man has strived to perfect his methods of gathering food, Mankind's earliest inventions came about as a result of his need to keep himself alive. My invention is a further refinement of this art of gathering food and in this case, fish. Humans have continuously striven to improve their techniques for gathering food in the most efficient manner possible. I believe that this invention is a unique tool and is at the pinnacle of simplicity, durability and effectiveness within the scope of today's technology.

The problem my invention solves is the capture of light biting fish in the winter period of the year. The fish that my device targets are the focus of what most fisherman are after at this time of the year, pan-fish. The target species will include but not be limited to walleye, perch, crappies and sunfish. Pan-fish are sought by anglers all through the year but are most tasty when caught from a cold water environment. Cold water seems to firm up their flesh and make it sweeter than at any other time of the year. This is probably due to their decreased metabolism and subsequent reduced food intake. This tasty flesh is why fisherman will brave the harsh elements to capture them. Thus the dilemma: a tasty, highly prized game fish in a harsh environment and which, due to their reduced metabolism, are extremely light biting.

Needless to say numerous devices have been invented to aid in the capture of pan-fish. Earliest tip-ups were probably sticks secured in mounds of snow and watched by ancient fisherman till bites were observed via the sticks bouncing tip. As our planet's technology evolved, a host of new and improved devices were created to put more fish in the pan. In those days fishing was for sustenance more than sport. Numbers of fish was the main goal and the time spent in the field was what our job was. In today's busy society we now have limits on the amount of fish that we can keep and most of us have limits on the amount of time we can allot to this pursuit. Due to the time limits that our modern jobs place on us and the fact that we now get our food from stores and not the field, the focus of our time on the ice has changed. Now we try to catch as many fish, within the mandated limits, in as short a time period as possible. Fishing has become a sport and not a job. Sportsmen love to take advantage of the newest and latest tools that can help them maximize the pleasure derived from their limited time in this pursuit. If you can build a better device today's sophisticated sportsmen will perceive its advantages and embrace it.

It is ironic that from those earliest willow stick tip-ups my invention has evolved. As my passion for the outdoors grew so did my desire to participate in all aspects of hunting and fishing. It was inevitable that I began to take up ice fishing to fill the outdoor void in the frozen period of the year. On my earliest outings to a nearby lake the first pan fish species I targeted was the species known as crappie. It did not take long to realize that when caught through the ice they were among the tastiest fish I had ever eaten. They also taught me how light fish can bite in this frozen period of the year.

In our state, as in most other states, the use of unmanned ice-fishing fishing devices is permitted. I soon realized from watching other fisherman how these devices, known as tip-ups, could dramatically improve a fishermans catch rate and productivity. I started out by incorporating the traditional tip-up, which consisted of a cross shaped member, mast, reel and flag to my arsenal of ice-fishing devices. These devices were origionaly designed for the capture of larger fish such as northern pike. I soon came to realize that they were not designed with the sensativity need to indicate the light bites of pan fish. I also noticed that the cost saving inferrior grades of wood that they were constructed from did not hold up well in the harsh conditions associated with ice-fishing. I next began to try some of the new tip-ups appearing on the market. One example was the device described in U.S. Pat. No. 4,567,686 which was collapsible and made of high impact plastic. This device also incorporated a paddle that allowed it to jig the bait via the wind blowing on the paddle. Upon using it I soon realized that it also lacked the needed sensativity and I also found that it took up signigant space even when collapsed. I did like the action it imparted to the bait via the wind and I loved the durable plastic that it was made from.

I now began noticing a new device appearing on the ice scene which its owners called a tip-down. This device was very similar to the tip-up devices and is described in U.S. Pat. No. 6,079,142 This device was dramatically more sensitive than anything I had seen. Once again the wood it was constructed from was a weakness and the reel that was attached to it seemed unnecessary as in that most fish, when hooked, were quickly hand lined to the surface. The bases of these devices were square and bulky when stored. Another flaw was the way that the pole rested on the mast in that all the models I saw had the pole resting in a notch on top of the mast. I observed that quite often the fish would get the pole rocking so hard that they would pull the pole out of the notch and down the hole in the ice before the fisherman could get to the device.

The number one problem I observed was that there were no measures built into the devices to offset the weights of the lures and baits used or to bring the pole back into balance. This was also true when a fish struck and pulled the pole down, it stayed down and thus there was no way to tell if the fish was still on the line. Quite often I would set the hook and the fish would be gone and this in turn would scare the fish

It is another object of the invention to provide an ice fishing system which is extremely sensitive and offers minimal resistance to light biting fish.

It is another object of the invention to provide an ice fishing system which has a curved shaped which allows the pole to return to the quiescent position upon a fish dropping the bait, thereby alerting the fisherman that the fish is no longer on the line.

It is another object of the invention to provide an ice fishing system that has a method for applying several types of counterweight systems to adjust to any lure an angler might use and thus retain the balance thereof.

It is another object of the invention to provide an ice fishing system that has a unique pivot pin that allows the pole to easily be removed from the base, by the angler,

yet makes it nearly impossible for a fish to pull the pole from the base.

It is another object of the invention to provide an ice fishing system that provides a place where snow or ice to be placed on the base further securing it, and by being made of a durable material allows the easy removal of snow or ice at the conclusion of fishing without damaging the device.

It is another object of the invention to provide an ice fishing system that has a place for the pole to rest on when in the quiescent position and which keeps the pole from freezing to the ice.

### SUMMARY OF THE INVENTION

In accordance with the present invention, there is provided an ice fishing system having a one piece base made from a cylindrical material and which is bent in a U shape. As it lays parallel with the ice, the two cylindrical legs bend upwardly to a position slightly past vertical to form two masts. In the distal end of these masts there are provided recessed openings. Across the two legs parallel two the ice there is provided a support plate which acts as a place for the rear of the pole to rest in the quiescent position and which also acts as a means of strengthening the base. The pole also is made of a cylindrical material and is one piece and is curved in shape. In the center of the pole is an aperture through which a pivot pin passes and resides. The projecting ends of the pivot pin are then bent downwardly to form two legs. These legs will then reside in the recessed openings arising from the base when the pole is in the quiescent position. This allows the pole to freely rock back and forth between the masts. The pole also has a hole at the end thereof through which the line passes on its way to the hole in the ice. The pole also has a protrusion at a point between its tip end and midpoint, along the center line of the pole, through which there will be a hole. This protrusion acts as a guide for the line and will be the place where an (optional) wind sail will attach. Near the rear portion of the pole along the center line two posts protrude at opposing angles and act as the reel, a place for the line to be stored. A short distance beyond the reel and along the center line, a protrusion is disposed and of a bright colored material, a flag, which acts as a visual aid for the fisherman to determine strikes. This flag also acts as a place where weights can be crimped on to help balance the pole and offset the weight of the lure or bait. At the very rear of the pole, another post is disposed along the center line and acts as a place where weights can be slid on to further help in offsetting the lures weight. These weights will be held in place by an O-ring . . .

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view view of a preferred embodiment of the ice fishing system constructed in accordance with the present invention;

FIG. 2 is a right elevation view of the system shown in FIG. 1;

FIG. 3 is a top elevation view of an of the prior figures;

FIG. 4 is a cross sectional view of the recessed openings in the masts of the base;

FIG. 5 is a cross sectional view of the aperture in the guide of the pole;

FIG. 6 is a top sectional view of the guide hole in the tip end of the pole;

FIG. 7 is a front perspective view of the wind sail attachment; and

FIG. 8 is an exploded view view of the system shown in prior figures.

For purposes of clarity and brevity, like elements and components will bear the same designations and numbering throughout the Figures.

### DESCRIPTION OF THE PREFERRED EMBODIMENT

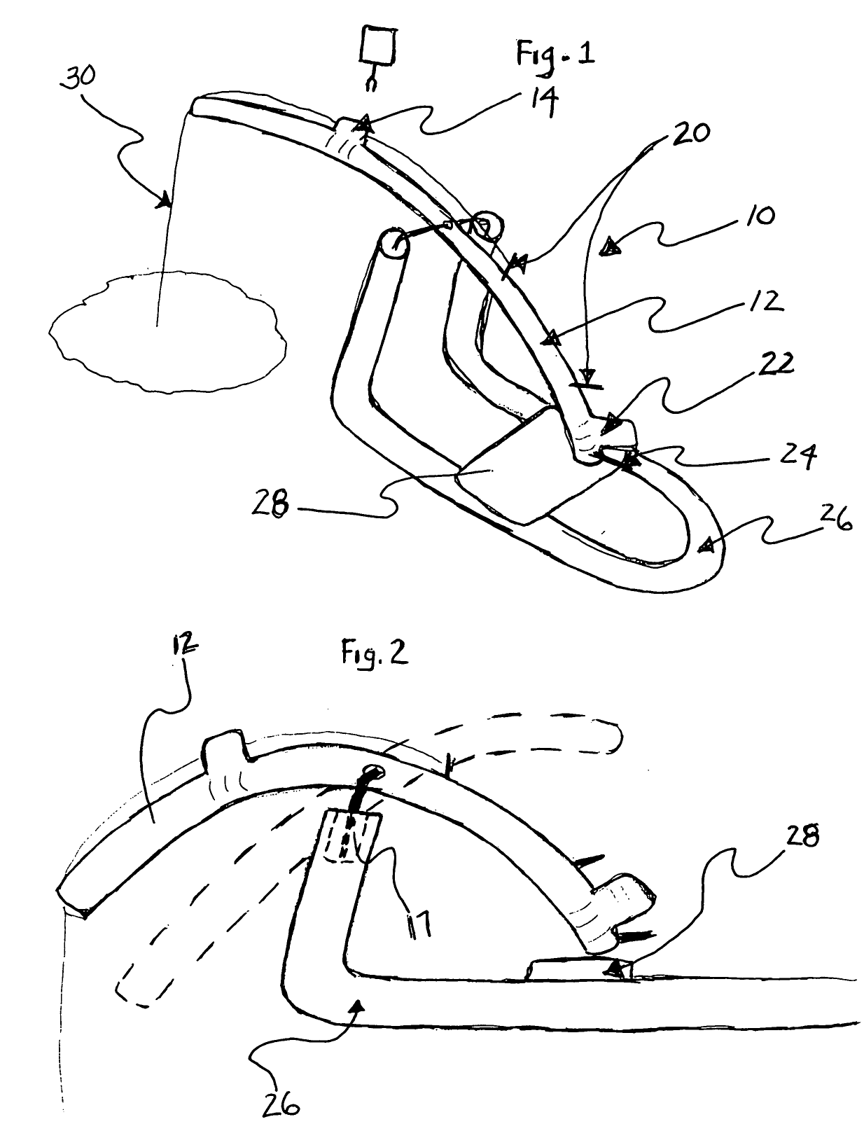

FIG. 1 is a perspective view of the embodiment of the invention and the new and improved ice fishing system embodying the principles and concepts of the present invention.

The present invention, the ice fishing system, is comprised of a plurality of components. The ice fishing system of the present invention comprises of a fishing pole 12 which is bent in a curved shape and is of a cylindrical material. The pole 12 has a tip aperture 34 through which the fishing line 30 passes and depends therefrom as it journeys towards the hole in the ice. Mid way between the tip aperture 34 and the pivot pins the guide 14 which protrudes from the pole 12 and it is through this guide 14 that the line passes as it travels from the reel 20 to the tip aperture 34. This guide 14 also is the place where the (optional) wind sail 36 is attached to the pole 12 when a fisherman chooses to employ it. At the midpoint of the pole 12 a pin aperture 18 will be provided. Through this pin aperture 18 the pivot pin 16 will travel and reside. This pivot pin 16 forms the connection between the pole 12 and the base 26 when the system is in the quiescent position. The legs of the pivot pin 16 will reside in the recessed openings 17 when the system is in the quiescent position. Between the pivot pin 16 and the flag 22, two posts will protrude from the pole 12, along the top center line, at opposing angles. These posts will be hence called the reel 20 and be the place where the line will be stored and originate from. Just beyond the reel 20, a flag 22 will protrude from the pole along the top center line. This flag 22 will be thin and brightly colored as to alert a fisherman that a strike is occurring by its eye catching motion. This flag 22 will also be a place where crimp on weights can be placed to help offset the weight of lures or baits and bring the system back into balance. At the very rear of the pole 12, along the top center line, a counterweight post 24 will protrude. On this counterweight post 24 weights can be slid on to offset lure or bait weights and bring the system back into balance. These weights will be held in place by an O-ring 42.

The base 26 will be bent in a U-shape as it lays parallel with the ice and then bend upwardly to form two masts. Each of these masts will have a recessed opening in it. The legs of the pivot pin 16 will slide into these recessed openings 17 and reside there when the system is in the quiescent position. Across the base 26, on the part that lays flush with the ice, a support plate 28 will be attached. This plate will help to keep the masts from flexing apart. This support plate 28 will also be where the reel 20 end of the pole 12 will rest when the system is in the quiescent position.

FIG. 2 is a right elevation of the ice fishing system showing how the pole 12 rocks to and fro as it sits on the base 26.

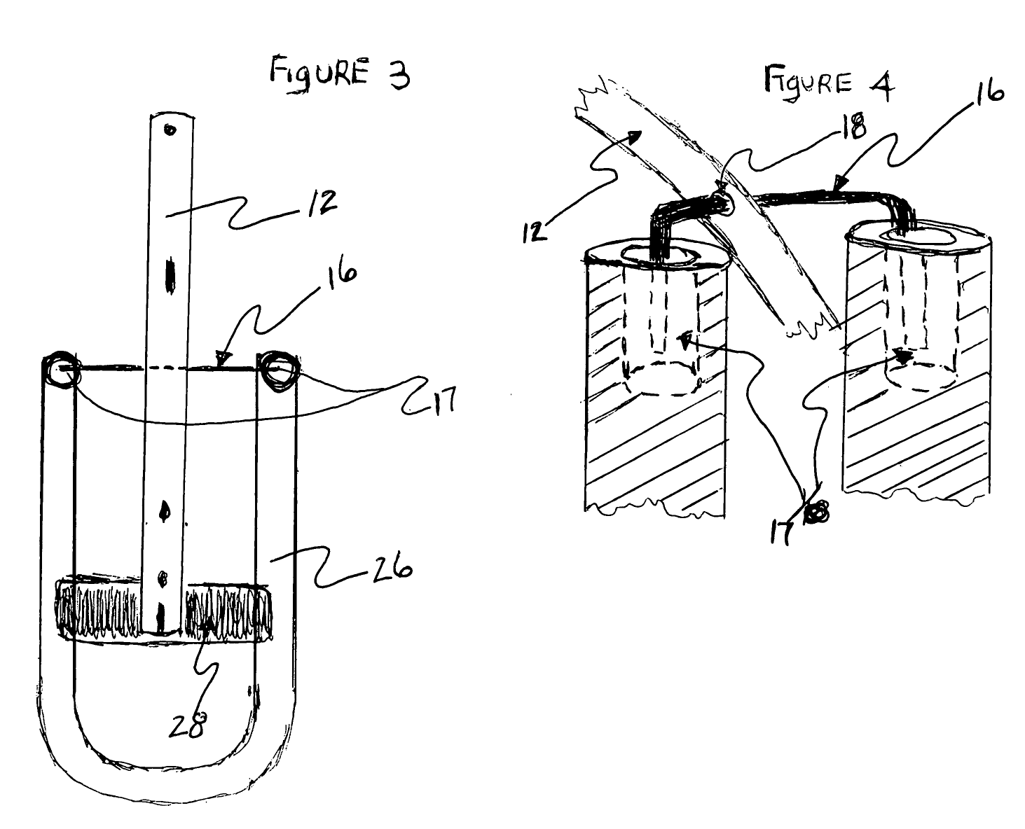

FIG. 3 is a top view of the ice fishing system as it rests in the quiescent position.

FIG. 4 is a .cross sectional view of the recessed openings 17 in the masts. This view also shows how the legs of the pivot pin 16 sit in the recessed openings 17 when the ice fishing system is in the quiescent position. This view shows how the pivot pin 16 passes through the pole 12. It also shows how the pivot pin 16 resides in the pin aperture 18.

FIG. 5 is a cross sectional view of the aperture in guide 32.

FIG. 6 is a top sectional view showing the tip aperture 34.

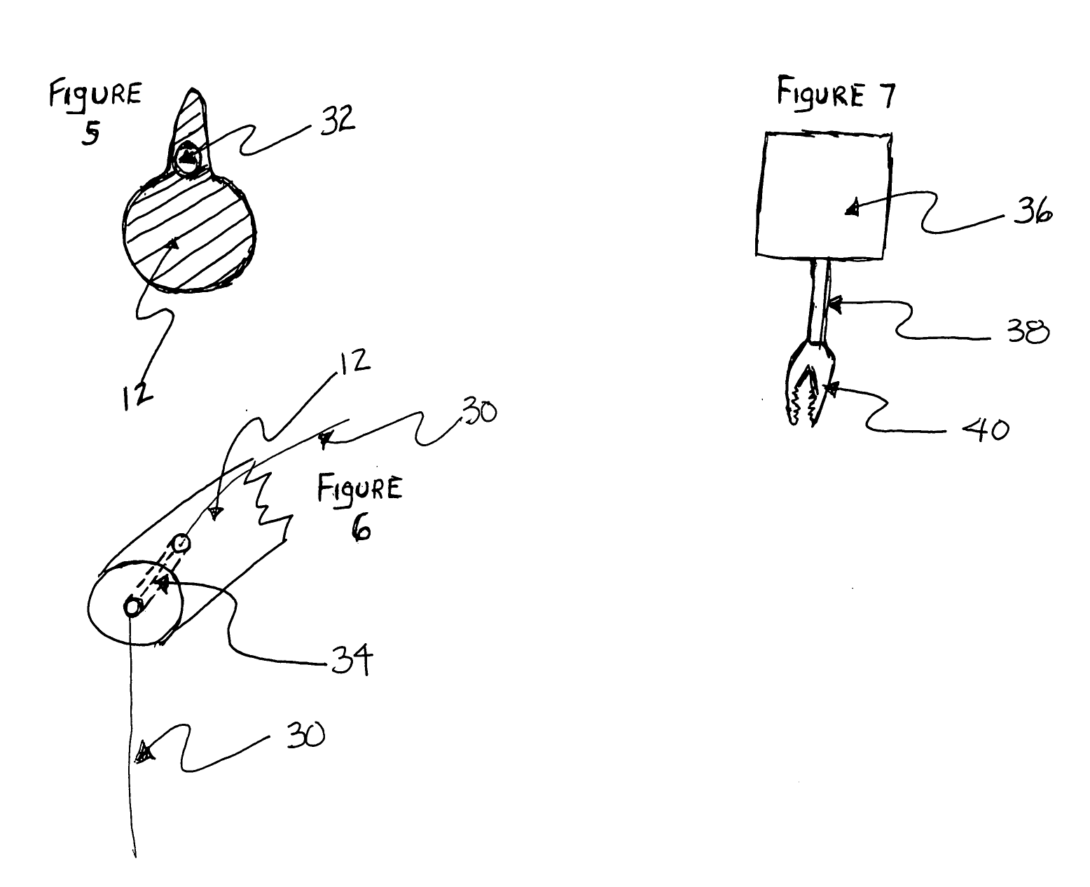

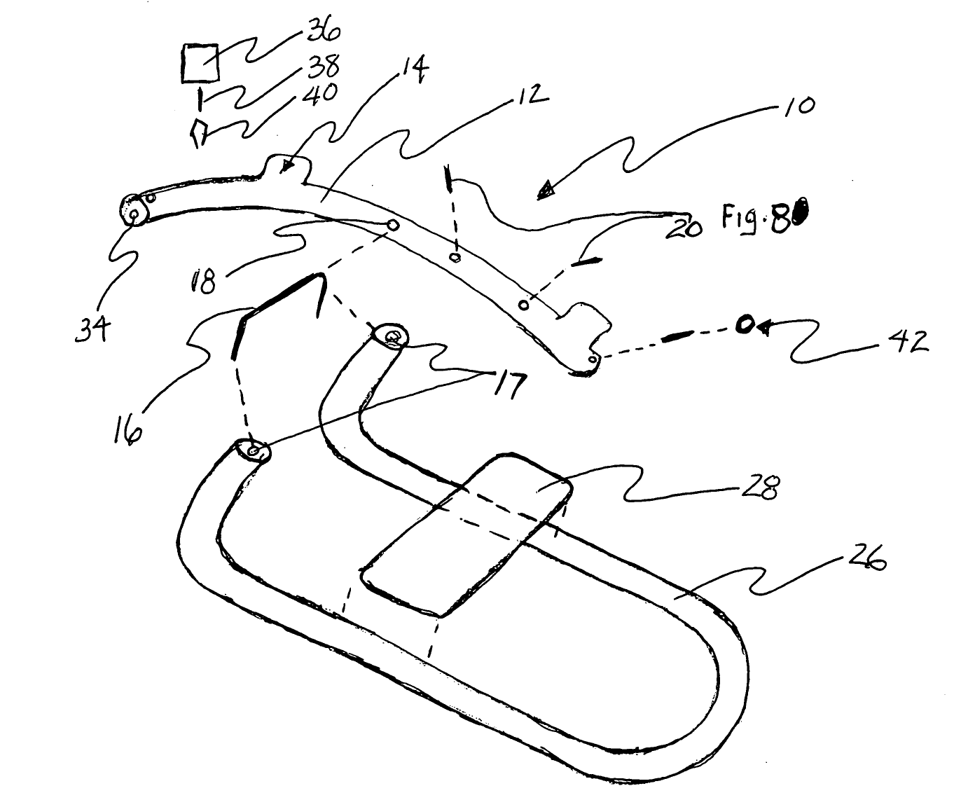

FIG. 7 is a front perspective of the optional wind sail 36 showing the three parts that comprise it. These parts are the sail 36, the post for the sail 38 and the clamp 40 that attaches the wind sail 36 to the guide 14.

FIG. 8 is an exploded view of the embodiment of the invention 10.

When fishing with the system of the present invention, while in the quiescent position, the pole 12 resides between the two masts of the base 26 with the flag 22 end of the pole 12 resting on the support plate 28 and the tip end of the pole 12 raised in the air. Upon the strike of a fish, the tip end of the pole 12 is pulled down towards the ice and the flag 22 end is raised into the air alerting the fisherman that a strike is occurring fisherman then snatches the pole 12 from the base 26, sets the hook and hand lines the fish to the surface. If the fish drops the bait before the fisherman can get to the system then the system will return to the quiescent position due to the built in counterweight measures. The object is to have the system slightly over balanced so that the flag 22 end rests on the support plate 28.

An appealing feature of the present invention is its ability to help a fisherman catch more of the light biting species, which he is seeking. This is due to the minimal resistance created by the curved design of the pole 12 much as a rocking chair provides minimal resistance to the person rocking in it.

Another appealing feature is the connection formed by the pivot pin 16 between the pole 12 and the base 26. The legs of the pivot pin 16 reside inside the masts of the base 26 and make it difficult for a fish to pull the pole 12 from the base 26 before a fisherman can reach the system. At the same time these legs of the pivot pin 16 easily slide out of the masts when a fisherman snatches the pole 12 from the base 26 and sets the hook.

Another appealing feature is the counterweight measures designed into the system that allows the fisherman to offset the weight of any lure or bait. This makes it possible to bring the system back into the slightly over balanced, flag 22 end of the pole 12 resting on the support plate 28, quiescent position.

Another appealing feature is that if a fish lets go of the bait before the fisherman can get to the system the pole 12 will return to the quiescent position and the fisherman will not set the hook prematurely, possibly alerting the fish that something is not right. Quiet often when a fish drops the bait the action of the system returning to the quiescent position and pulling the bait away from the fish, will cause the fish to strike again.

Another appealing feature is the ability for a fisherman to heap slush ice or snow on the U-shaped portion of the base 26 further securing it in place.

Another appealing feature is the smooth bends and cylindrical materials employed in the system. These not only make the system easy to handle, with few sharp edges, but also make the system visually appealing.

Another appealing feature is that the system is designed to fit inside the confines of a 5-gallon pail when being transported. The 5-gallon pail is the readily available item that many ice fishermen use for storing and transporting ice fishing equipment.

Another appealing feature is the durable plastic that the system is constructed from.

Another appealing feature is the economical manufacturing costs. This helps to keep the cost down to a price where most anglers can afford the system.

Another appealing feature is how few moving part and parts in general that comprise the system. This allows for almost no way that the system can freeze up in harsh conditions of ice fishing and less chance of parts getting lost.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A tip-up fishing device for ice fishing for a new and more sensitive ice fishing device, comprising:
a fishing pole; means for guiding a fishing line from a reel to a tip aperture disposed in said pole, rigidly connected to said fishing pole;
means for supporting the pole in the quiescent position;
means for facilitating to and fro motion to the pole and forming the connection between the pole and the base in the quiescent position, insertably connected to said means for providing a place where the leg of the pivot pin to reside; and
means for receiving said means for facilitating to and fro rocking motion, internally embedded in said means for supporting the pole in the quiescent position.

2. The tip-up fishing device for ice fishing in accordance with claim 1, wherein said fishing pole comprises an arcuate shaped pole.

3. The tip-up fishing device for ice fishing in accordance with claim 1, wherein said means for guiding a fishing line from a reel to a tip aperture comprises a guide.

4. The tip-up fishing device for ice fishing in accordance with claim 1, wherein said means for supporting the pole comprises a base.

5. The tip-up device for ice fishing in accordance with claim 1, wherein said means for facilitating to and fro rocking motion comprises a pivot pin.

6. The tip-up fishing device for ice fishing in accordance with claim 1, wherein said means for receiving said pivot pin comprises a recessed opening.

7. A tip-up fishing device for ice fishing for a new and more sensitive ice fishing device, comprising:
an arcuate shaped pole for extending a fishing line;
a guide, for guiding the fishing line from a reel to said tip aperture rigidly connected to said pole;
a base, for providing the place where the pole resides in the quiescent position;
a pivot pin, for allowing said pole to rock to and fro and forming the connection between the pole and the base in the quiescent position, insertably connected to a recessed opening; and
a recessed opening in said base, for receiving at least one leg of the pivot pin, internally embedded in said base.

8. The tip-up fishing device for ice fishing as recited in claim 7, further comprising:
a reel for storing the fishing line, rigidly connected to said pole.

9. The tip-up fishing device for ice fishing as recited in claim 7, further comprising:
a flag, for alerting fisherman to a strike and where weights can be crimped on to offset lure weights, rigidly connected to said pole.

10. The tip-up fishing device for ice fishing as recited in claim 7, further comprising:
a counter weight post, for placing slide-on weights to offset lure weights, rigidly connected to said pole.

11. The tip-up fishing device for ice fishing as recited in claim 7, further comprising:
a support plate, for strengthening the base and providing a place where the rear of the pole resides in the quiescent position, rigidly connected to said base.

12. The tip-up fishing device for ice fishing as recited in claim 7, further comprising:
a pin aperture, for providing a place for the pivot pin to pass through the pole, internally embedded in said pole, and insertably connected to said pivot pin

13. The tip-up fishing device for ice fishing as recited in claim 7, further comprising:
an aperture formed in said guide, for providing a place for the line to pass through the guide, internally embedded therein.

14. The tip-up fishing device for ice fishing as recited in claim 7, further comprising:
a tip aperture, for providing a place for the line to pass through the pole, internally embedded therein.

15. The tip-up fishing device for ice fishing as recited in claim 7, further comprising:
a wind sail supported by said guide, for catching the wind to impart action to the device.

16. A tip-up fishing device for ice fishing comprising:
a base, for providing a sturdy foundation for a fishing pole to rest upon in the quiescent position, having an area provided where snow or slush can be heaped on to further stabilize and secure said base to the ice, bent to form at least one mast upon which the fishing pole resides when in the quiescent position;
a curved shaped fishing pole, for rocking down upon the strike of a fish and rocking back to its quiescent position upon a fish dropping the lure or bait;
a pivot pin, having at least one leg for providing a place for said pole to rock to and fro and for providing means for connecting the pole to the base in the quiescent position;
an opening in the base for receiving said at least one leg of the pivot pin when the system is in the quiescent position, insertably coupled to said pivot pin; and
a guide for guiding the fishing line on its path from the reel to the tip of the pole, rigidly connected to said pole.
